(19) United States
(12) Patent Application Publication
(10) Pub. No.: US 2022/0022562 A1
(43) Pub. Date: Jan. 27, 2022

(54) SUPPORTER JERSEY

(71) Applicant: Get Branded Pty Ltd, Red Hill (AU)

(72) Inventors: Madonna SIMMONS, Mysterton (AU); Peter SIMMONS, Mysterton (AU)

(21) Appl. No.: 17/311,369

(22) PCT Filed: Dec. 6, 2019
(86) PCT No.: PCT/AU2019/051338

§ 371 Date: Jun. 7, 2021

(30) Foreign Application Priority Data
Dec. 7, 2018 (AU) 2018904675
Oct. 31, 2019 (AU) 2019904112

(51) Int. Cl. A41D 1/04; A41D 15/04

(52) U.S. Cl. CPC A41D 1/04; A41D 15/04

(57) ABSTRACT

A supporter jersey comprising a wearable top having a front portion and a back portion, wherein the front portion is partially detachable from the back portion.

### TECHNICAL FIELD

The present invention relates to a supporter jersey (a jersey in the form of a wearable top for a supporter to wear) and, in particular, relates to a supporter's jersey having indicia printed on both the inside and outside.

### BACKGROUND

Any references to methods, apparatus or documents of the prior art are not to be taken as constituting any evidence or admission that they formed, or form part of the common general knowledge.

Supporters and fans present at sporting events, such as football and soccer matches, are often provided with, or bring their own, barracking paraphernalia that they utilise when their team or sportsperson is ahead of the competition or achieves a positive result (i.e. a try or goal, for example).

These assorted paraphernalia, which often comprise roll up banners, flags and blow up toys and the like, can be effective for showing support for a fan's team or sportsperson but can become a nuisance or difficult to wield when the fan/supporter is also attempting to eat food and/or enjoy a beverage during the course of the sporting event.

In addition, these paraphernalia may often be discarded after the sporting event, ultimately amounting to large amounts of plastic waste that will end up in landfill.

Thus, there is a need for an improved way for attendees at sporting events to show support for their team/sportsperson.

### OBJECT OF THE INVENTION

It is an aim of this disclosure to provide a supporter jersey which overcomes or ameliorates one or more of the disadvantages or problems described above, or which at least provides a useful commercial alternative.

Other preferred objects of the present invention will become apparent from the following description.

### SUMMARY OF INVENTION

In a first aspect, the invention provides a supporter jersey to be worn by a supporter of a particular team (e.g. a football team) or sportsperson.

In another aspect, the invention provides a supporter's jersey comprising a wearable top having a front portion and a back portion which are partially detachable from one another. The front portion and back portion are detachable along a longitudinal seam and remain fixedly connected along a lateral seam extending across a shoulder portion of the wearable top.

Preferably, the jersey comprises a first indicia located on an internally facing surface of the jersey. Preferably, the jersey also comprises a second indicia located on an externally facing surface of the jersey opposite the first indicia.

The jersey comprises a sleeveless jersey having a front portion and a back portion. The front and back portions comprise seamless side edge portions releasably fastened to each other. The seamless side edge portions may be releasably fastened by one or more fasteners, such as press studs or zippers.

The fasteners may comprise one or more press studs, one or more buttons and complementary buttons holes or a hook and loop fastener (e.g. a Velcro fastener).

In some embodiments, the jersey is a tank top, singlet or shirt.

In some embodiments, the jersey comprises a front portion and a back portion which are partially detachable from one another. Preferably, the front portion and the back portion are stitchedly attached at a shoulder portion of the jersey. In a singlet or tank top embodiment, the shoulder portion may comprise a strap that rests on the shoulder of a wearer.

Preferably, the front portion and the back portion are connected by two opposing side portions extending between the front portion and the back portion. Preferably, the side portions are releasably connected or releasably attached to the front portion on opposing sides of the front portion by one or more fasteners, such as a zipper.

Preferably, the jersey comprises an undergarment portion. Preferably, the undergarment portion comprises a material layer adjacent the front portion. Preferably, the undergarment portion is located between the front portion and the back portion. Preferably, the undergarment is attached to the back portion or side portions. Preferably, the undergarment portion is located within the tank top, singlet or shirt.

Preferably, the front portion and the back portion comprise a material layer.

Preferably, the partially detachable front portion is operable to be moved between a first position and a second position along a longitudinal axis. Preferably, the longitudinal axis extends longitudinally through the jersey.

Further features and advantages of the present invention will become apparent from the following description.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is an illustration of a front portion of a supporter jersey according to an embodiment of the present invention;

FIG. 2 is a view of the front and back portions of the supporter jersey shown in FIG. 1;

FIG. 3 is an illustration of the front portion of the support jersey lifted above the back portion;

FIGS. 4 a-c is an illustration of the supporter jersey in use by a supporter wearing the jersey;

FIGS. 5 a-c is an illustration of a supporter jersey according to another embodiment of the present invention;

FIGS. 6 a-b is an illustration of the supporter jersey of FIG. 5 in use by a supporter wearing the jersey;

FIGS. 7 a-c is an illustration of a supporter jersey according to another embodiment of the present invention; and

FIGS. 8 a-b is an illustration of the supporter jersey of FIG. 7 in use by a supporter wearing the jersey.

### DETAILED DESCRIPTION OF PREFERRED EMBODIMENTS

The present disclosure provides a supporter jersey to be worn by a supporter of a particular team (e.g. a football team) or sportsperson.

The supporter jersey is a wearable top (in the form of a singlet, shirt or tank top, for example) having a front portion and a back portion which are partially detachable from one another. The front portion and back portion are detachable along a longitudinal seam and remain fixedly connected along a lateral seam extending across a shoulder portion of the wearable top.

The front portion and back portion are detachable along a longitudinal seam and remain fixedly connected along a lateral seam extending across a shoulder portion of the wearable top.

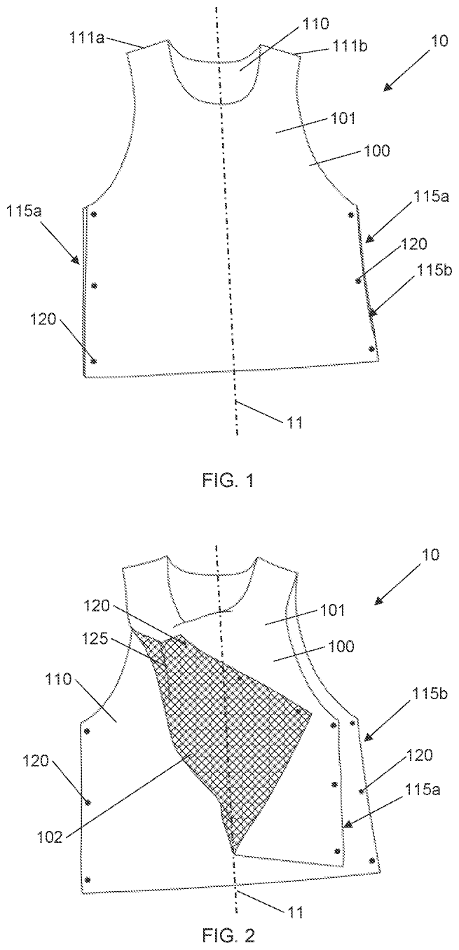

FIGS. 1 to 3 illustrate a jersey 10 to be worn by a supporter of a particular team or sportsperson to show support for said team or sportsperson.

The jersey 10 shown in the illustrated embodiment is a wearable top in the form of a sleeveless jersey (also commonly referred to as a singlet, guernsey or tank top) having a front portion 100 and a back portion 110 releasably fastened together by respective seamless side edge portions 115a, 115b such that the front portion 100 and back portion 110 are partially detachable from one another, remaining attached at the shoulder portions 111a, 111b where the front portion 100 and back portion 110 meet and, during wearing, would rest across the wearer's shoulders. The side edge portions 115a, 115b define edges of the front portion 100 and back portion 110, respectively.

The seamless side portions 115a, 115b shown in the illustrated are detachable or releasably fastened by a set of fasteners in the form of press studs 120. However, the side portions 115a, 115b could be fastened together using any suitable fastener, including a hook-and-loop fastener, buttons and complementary button holes, zips or zippers, or magnets, for example. In some alternative embodiments, the side portions may not have any fasteners.

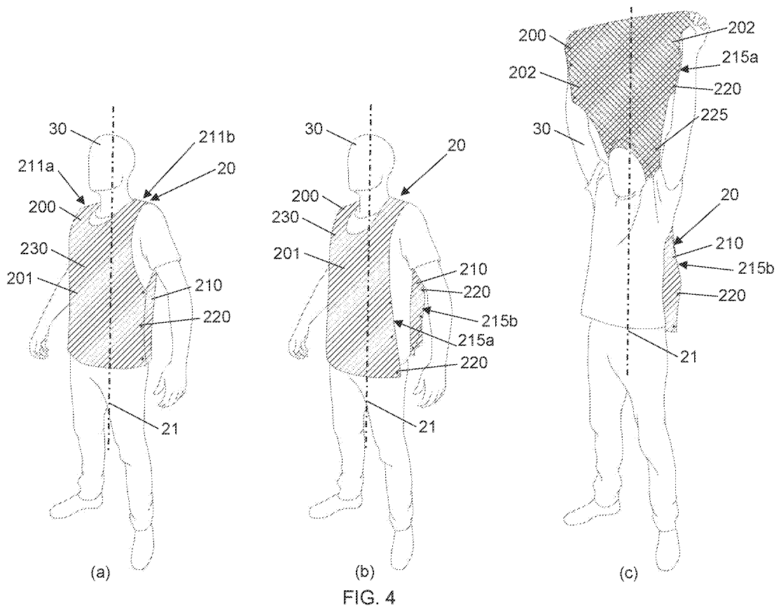

The externally facing portion 101 of the front portion 100 of the jersey 10 is adapted to have an optional first indicia, such as a team name, logo or slogan, for example, printed thereon. While this is not shown in the present embodiment, it is shown in the embodiment illustrated in FIG. 4 and will be described below.

In addition to the first external indicia, a second internal indicia (indicated by pattern 125), which may take the form of a logo or team name but could also be in the form of specific outcome related words such as “GOAL” or “TRY”, is printed or otherwise displayed on the internally facing portion 102 of the front portion 100 of the jersey 10.

In use, a person would wear the jersey 10 as shown in FIG. 1 having the side portions 115a, 115b fastened together to an event.

Upon commencement of the event, the wearer then unfastens the press studs 120 to detach the front portion 100 from the back portion 110 along the seamless side portions 115a, 115b.

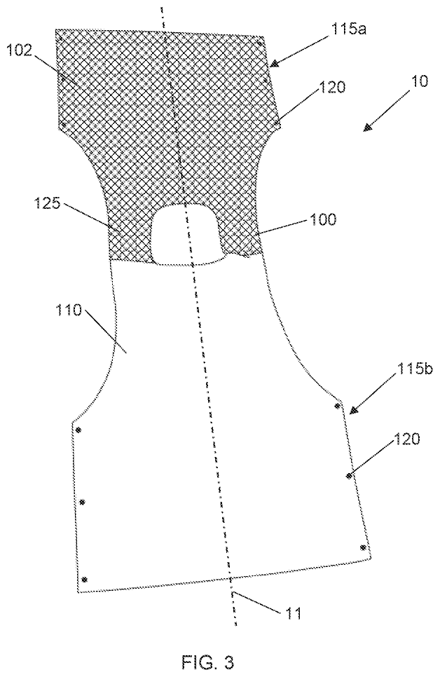

At particular times of the event, the wearer would then lift the front portion 100 of the jersey 10 over their head, to the position shown in FIG. 3 to thereby display the indicia printed on the normally internally facing front portion 102 of the front portion 100 of the jersey 10. The front portion 100 is therefore operable to be moved between a first position (i.e. showing the externally facing portion 101 of the front portion 100 as in FIG. 1) and a second position (i.e. showing the internally facing portion 102 of the front portion 100 as in FIG. 3) along a longitudinal axis 11 which extends through the jersey 10.

Turning to FIG. 4, another embodiment of the jersey 20, which is substantially similar to jersey 10 shown in FIG. 1-3, having a front portion 200, a back portion 210, side portions 215a, 215b, fasteners 220 and internally located indicia 225 (indicated by the cross-hatched lines) located on an internally facing portion 202 of the front portion 200 of the jersey 20.

The front portion 200 and back portion 210 are partially detachable from one another, remaining attached at the shoulder portions 211a, 211b where the front portion 200 and back portion 210 meet.

Jersey 20 also includes external indicia 230 (indicated by the diagonal lines) printed on the externally facing portion 201 (including the front portion 200 and back portion 210 in the illustrated embodiment) of the jersey 20, is shown being worn by a supporter 30. The external indicia 230 is likely to be a logo or iconography representative of a particular team or sportsperson but could, of course, be any thing.

It is envisioned that the supporter 30 would wear the jersey 20 as shown in FIG. 4 (a) having the side portions 215 fastened together when arriving at the venue hosting the sporting event.

Upon commencement of the event, the supporter 30 may then choose to unfasten the fasteners 220 located on the side portions 215 of the jersey 20, as shown in FIG. 4 (b) to be ready to use the jersey 20 to show support for their team/sportsperson at the appropriate time.

Subsequently, in the event that the relevant sportsperson/team achieves a particular result, such as scoring a try or goal, the supporter 30 would then lift the front portion 200 of the jersey 20 over their head, as shown in FIG. 4 (c) to thereby display the indicia 225 printed on the internal surface of the jersey 20. The front portion 200 is therefore operable to be moved between a first position (i.e. showing the externally facing portion 201 of the front portion 200 as in FIGS. 4(a) and 4(b)) and a second position (i.e. showing the internally facing portion 202 of the front portion 200 as in FIG. 4(c)) along a longitudinal axis 21 which extends through the jersey 20.

As described above, the internal, secondary indicia 225 may comprise some form of recognition of a certain result, such as spelling out the word “GOAL” or may comprise an encouraging slogan, such as “LET'S GO!”, for example.

While the supporter 30 in FIG. 4(c) has been shown to use both arms to lift the front portion of the jersey 20, it is envisioned that the supporter 30 may also use only one arm to them hold a phone/food/drink/etc. with their free hand.

The jerseys described in the embodiments above can be made from any durable fabric suitable for wearing, such as a cotton or polyester, for example. Furthermore, the indicia may be printed, iron-on transfer, woven into the fabric of the jersey or any suitable method of incorporating indicia onto/into the jersey.

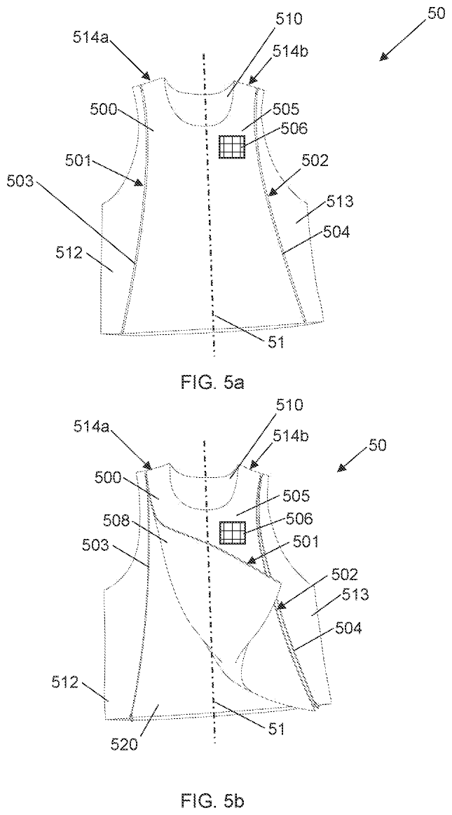

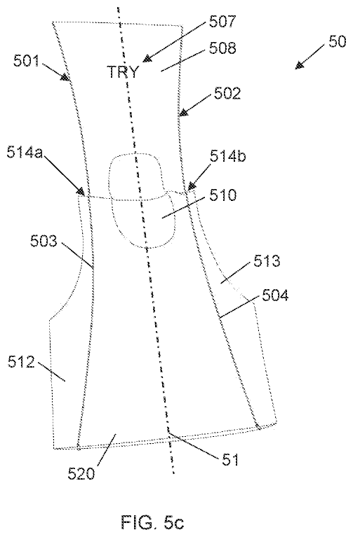

Turning to FIGS. 5a, 5b and 5c, there is shown a supporter jersey 50 in the form of a singlet or tank top (as described above).

The jersey 50 includes a front portion 500 and a back portion 510 attached to side portions 512, 513 extending around the side of the jersey 50 between the front portion 500 and the back portion 510. Each of the side portions 512, 513 are releasably connected to the front portion 500 along opposing longitudinal edges 501, 502 of the front portion 500 by respective zippers 503, 504, such that the front portion 500 is partially detachable from the back portion 510 and side portions 512, 513.

The normally externally facing portion 505 of the front portion 500 of the jersey 50 may include one or more first indicia, such as a team logo indicated by block 506, printed thereon.

In addition to the first external indicia, a second internal indicia 507 indicated by the word “TRY” (any word, symbol, logo, picture or combination of these could be printed) is printed or otherwise displayed on the normally internally facing front portion 508 of the front portion 500 of the jersey 50.

With specific reference to FIG. 5(c), it can be seen that the front portion 500, when lifted, remains attached to the back portion 510 at the shoulder portions 514a, 514b of the jersey 50. The front portion 500 can be attached to the back portion 510 at the shoulders portions 514a, 514b by any suitable means, such as stitching.

There is also provided an inner lining or undergarment portion 520 that sits beneath front portion 500 when front portion 500 is attached by the zippers 503, 504 to the side portions 512, 513. The undergarment portion 520 may take the form of a piece of material that extends across the front portion 500 of the jersey 50 behind the front portion 500 (or within the jersey 50) or may comprise a whole garment that is the same shape as the wearable top and the undergarment is stitched attached to the interior of the wearable top to create a shirt within a shirt (or singlet within a singlet).

The undergarment portion 520 is fixedly attached to the side portions 512, 513, by stitching for example, and provides a material cover for a wearers torso when they lift the front portion 500 upon in support. While not essential, the undergarment portion 520 is particularly useful over the embodiments described above for people who are somewhat modest and/or do not wish to expose parts of their body, particularly in colder climates.

It is envisioned that a supporter would wear the jersey 50 as shown in FIG. 5(a) having the side portions 512, 513 fastened to the front portion 500 together when arriving at the venue hosting the sporting event.

Upon commencement of the event, the supporter 50 may then choose to unzip the zippers 502, 503 fastening the side portions 512, 513 to the front portion 500 of the jersey 50, to be ready to use the jersey 50 to show support for their team/sportsperson at the appropriate time.

Subsequently, in the event that the relevant sportsperson/team achieves a particular result, such as scoring a try or goal, the supporter would then lift the front portion 500 of the jersey 50 over their head, as shown in FIG. 5(b) to thereby display the indicia printed on the normally internally facing front portion 508 of the front portion 500 of the jersey 50. The front portion 500 is therefore operable to be moved between a first position (i.e. showing the externally facing portion 505 of the front portion 500 as in FIG. 5(a)) and a second position (i.e. showing the internally facing portion 508 of the front portion 500 as in FIG. 5(c)) along a longitudinal axis 51 which extends through the jersey 50.

As described above, the internal, secondary indicia may comprise some form of recognition of a certain result, such as spelling out the word “GOAL” or “TRY” or may comprise an encouraging slogan, such as “LET'S GO!”, for example.

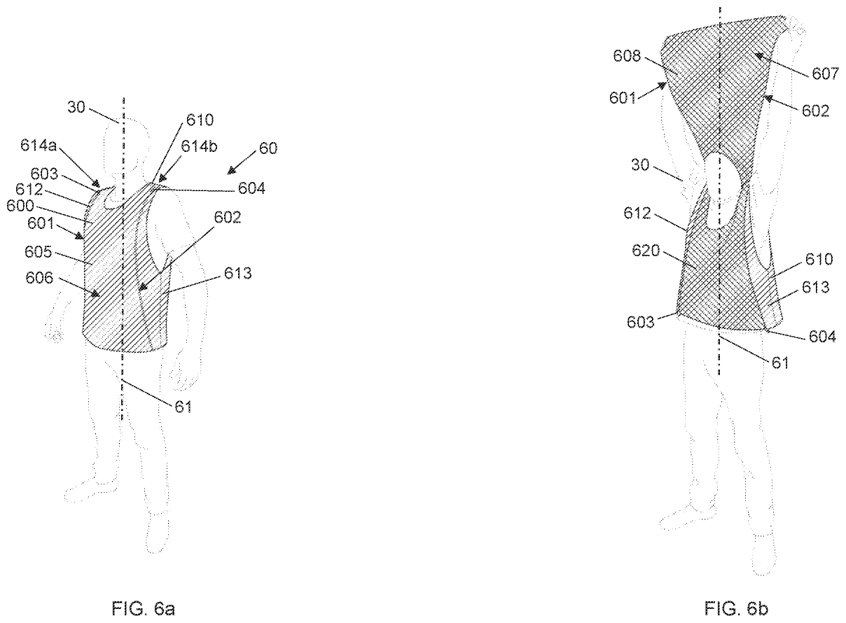

Turning to FIGS. 6a and 6b, there is shown a supporter jersey 60 in the form of a singlet or tank top (as described above).

The jersey 60 includes a front portion 600 and a back portion 610 attached to side portions 612, 613 extending around the side of the jersey 60 between the front portion 600 and the back portion 610.

Each of the side portions 612, 613 are releasably connected to the front portion 600 along opposing longitudinal edges 601, 602 of the front portion 600 by respective zippers 603, 604, such that the front portion 600 is partially detachable from the back portion 610 and side portions 612, 613.

The normally externally facing portion 605 of the front portion 600 of the jersey 60 includes one or more first indicia, exemplified by pattern 606, printed thereon. The first indicia may be a team logo or name, in some embodiments.

In addition to the first external indicia, a second internal indicia (exemplified by pattern 607) is printed or otherwise displayed on the normally internally facing portion 608 of the front portion 600 of the jersey 60.

With specific reference to FIG. 6b, it can be seen that the front portion 600, when lifted by wearer 30, remains attached to the back portion 610 at the shoulder portions 614a, 614b of the jersey 60. The front portion 600 and back portion 610 can be attached at the shoulder portions 614a, 614b by any suitable means, such as stitching.

There is also provided an inner lining or undergarment portion 620 that sits beneath front portion 600 when front portion 600 is attached by the zippers 603, 604 to the side portions 612, 613.

The undergarment portion 620 is fixedly attached to the side portions 612, 613, by stitching for example, and provides a material cover for a wearer's torso when they lift the front portion 600 upon in support. While not essential, the undergarment portion 620 is particularly useful over the embodiments described above for people who are somewhat modest and/or do not wish to expose parts of their body, particularly in colder climates.

It is envisioned that a supporter would wear the jersey 60 as shown in FIG. 6a having the side portions 612, 613 fastened to the front portion 600 together when arriving at the venue hosting the sporting event.

Upon commencement of the event, the supporter 60 may then choose to unzip the zippers 602, 603 fastening the side portions 612, 613 to the front portion 600 of the jersey 60, to be ready to use the jersey 60 to show support for their team/sportsperson at the appropriate time.

Subsequently, in the event that the relevant sportsperson/team achieves a particular result, such as scoring a try or goal, the supporter would then lift the front portion 600 of the jersey 60 over their head, as shown in FIG. 6b to thereby display the indicia printed on the normally internally facing front portion 608 of the front portion 600 of the jersey 60. The front portion 600 is therefore operable to be moved between a first position (i.e. showing the externally facing portion 605 of the front portion 600 as in FIG. 6(a)) and a second position (i.e. showing the internally facing portion 608 of the front portion 600 as in FIG. 6(b)) along a longitudinal axis 61 which extends through the jersey 60.

As described above, the internal, secondary indicia may comprise some form of recognition of a certain result, such as spelling out the word “GOAL” or “TRY” or may comprise an encouraging slogan, such as “LET'S GO!”, for example.

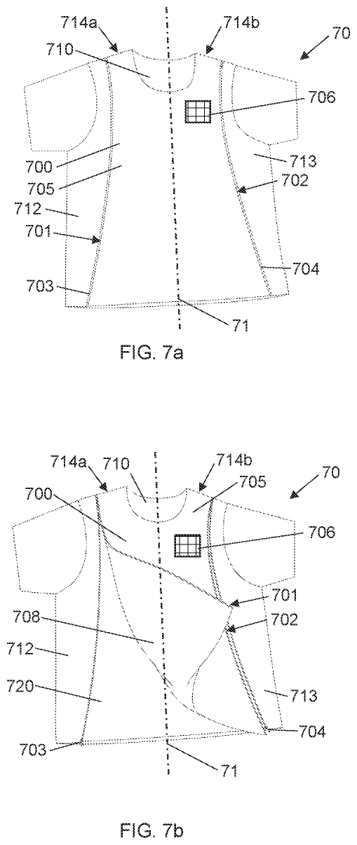

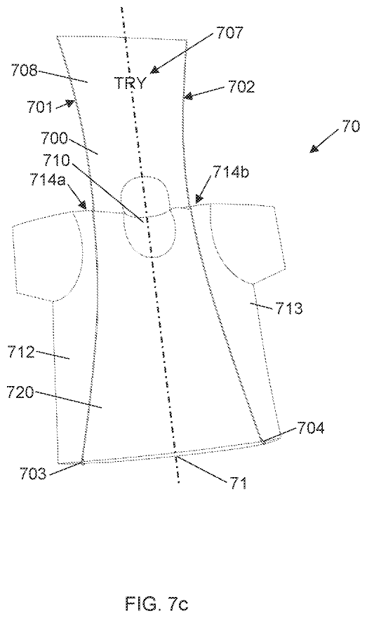

Turning now to FIGS. 7a, 7b and 7c, there is shown a supporter jersey 70 in the form of a shirt.

Jersey 70 includes a front portion 700 and a back portion 710 attached to side portions 712, 713 extending around the side of the jersey 70 between the front portion 700 and the back portion 710. Each of the side portions 712, 713 are releasably connected to the front portion 700 along opposing longitudinal edges 701, 702 of the front portion 700 by respective zippers 703, 704, such that the front portion 700 is partially detachable from the back portion 710 and side portions 712, 713.

The normally externally facing portion 705 of the front portion 700 of the jersey 70 may include one or more first indicia, such as a team logo indicated by block 706, printed thereon.

In addition to the first external indicia, a second internal indicia 707 indicated by the word “TRY” (any word, symbol, logo, picture or combination of these could be printed) is printed or otherwise displayed on the normally internally facing front portion 708 of the front portion 700 of the jersey 70.

With specific to FIG. 7c, it can be seen that the front portion 700, when lifted, remains attached to the back portion 710 at the shoulder portions 714a, 714b of the jersey 70. The front portion 700 can be attached to the back portion 710 by any suitable means, such as stitching.

There is also provided an inner lining or undergarment portion 720 that sits beneath front portion 700 when front portion 700 is attached by the zippers 703, 704 to the side portions 712, 713.

The undergarment portion 720 is fixedly attached to the side portions 712, 713, by stitching for example, and provides a material cover for a wearer's torso when they lift the front portion 700 upon in support. While not essential, the undergarment portion 720 is particularly useful over the embodiments described above for people who are somewhat modest and/or do not wish to expose parts of their body, particularly in colder climates.

It is envisioned that a supporter would wear the jersey 70 as shown in FIG. 7a having the side portions 712, 713 fastened to the front portion 700 together when arriving at the venue hosting the sporting event.

Upon commencement of the event, the supporter 70 may then choose to unzip the zippers 702, 703 fastening the side portions 712, 713 to the front portion 700 of the jersey 70, to be ready to use the jersey 70 to show support for their team/sportsperson at the appropriate time.

Subsequently, in the event that the relevant sportsperson/team achieves a particular result, such as scoring a try or goal, the supporter would then lift the front portion 700 of the jersey 70 over their head, as shown in FIGS. 7b and 7c to thereby display the indicia printed on the normally internally facing front portion 708 of the front portion 700 of the jersey 70. The front portion 700 is therefore operable to be moved between a first position (i.e. showing the externally facing portion 705 of the front portion 700 as in FIG. 7(a)) and a second position (i.e. showing the internally facing portion 708 of the front portion 700 as in FIG. 7(b)) along a longitudinal axis 71 which extends through the jersey 70.

As described above, the internal, secondary indicia may comprise some form of recognition of a certain result, such as spelling out the word “GOAL” or “TRY” or may comprise an encouraging slogan, such as “LET'S GO!”, for example.

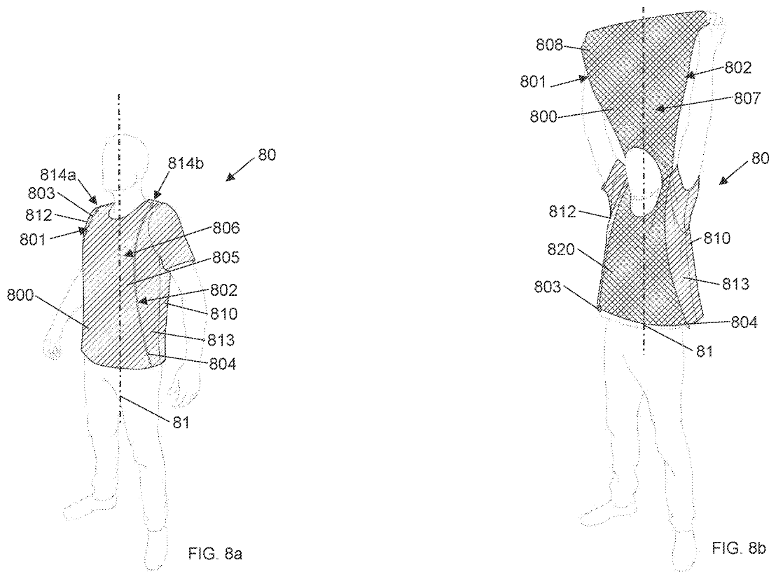

Turning now to FIGS. 8a and 8b, there is shown a supporter jersey 80 in the form of a shirt worn by a wearer 30.

Jersey 80 includes a front portion 800 and a back portion 810 attached to side portions 812, 813 extending around the side of the jersey 80 between the front portion 800 and the back portion 810. Each of the side portions 812, 813 are releasably connected to the front portion 800 along opposing longitudinal edges 801, 802 of the front portion 800 by respective zippers 803, 804, such that the front portion 800 is partially detachable from the back portion 810 and side portions 812, 813.

The normally externally facing portion 805 of the front portion 800 of the jersey 80 includes one or more first indicia, exemplified by pattern 806, printed thereon. The first indicia may be a team logo or name, in some embodiments.

In addition to the first external indicia, a second internal indicia (exemplified by pattern 807) is printed or otherwise displayed on the normally internally facing front portion 808 of the front portion 800 of the jersey 80.

With specific reference to FIG. 8b, it can be seen that the front portion 800, when lifted, remains attached to the back portion 810 at the shoulder portions 814a, 814b of the jersey 80. The front portion 800 can be attached to the back portion 810 by any suitable means, such as stitching.

There is also provided an inner lining or undergarment portion 820 that sits beneath front portion 800 when front portion 800 is attached by the zippers 803, 804 to the side portions 812, 813.

The undergarment portion 820 is fixedly attached to the side portions 812, 813, by stitching for example, and provides a material cover for a wearer's torso when they lift the front portion 800 upon in support. While not essential, the undergarment portion 820 is particularly useful over the embodiments described above for people who are somewhat modest and/or do not wish to expose parts of their body, particularly in colder climates.

It is envisioned that a supporter 30 would wear the jersey 80 as shown in FIGS. 8a and 8b having the side portions 812, 813 fastened to the front portion 800 together when arriving at the venue hosting the sporting event.

Upon commencement of the event, the supporter 80 may then choose to unzip the zippers 802, 803 fastening the side portions 812, 813 to the front portion 800 of the jersey 80, to be ready to use the jersey 80 to show support for their team/sportsperson at the appropriate time.

Subsequently, in the event that the relevant sportsperson/team achieves a particular result, such as scoring a try or goal, the supporter would then lift the front portion 800 of the jersey 80 over their head, as shown in FIG. 6(b) to thereby display the indicia printed on the normally internally facing front portion 808 of the front portion 800 of the jersey 80. The front portion 800 is therefore operable to be moved between a first position (i.e. showing the externally facing portion 805 of the front portion 800 as in FIG. 8(a)) and a second position (i.e. showing the internally facing portion 808 of the front portion 800 as in FIG. 8(b)) along a longitudinal axis 81 which extends through the jersey 80.

As described above, the internal, secondary indicia may comprise some form of recognition of a certain result, such as spelling out the word “GOAL” or “TRY” or may comprise an encouraging slogan, such as “LET'S GO!”, for example.

The embodiments of the invention described herein provide a convenient way for supporters at sporting events to show support for their chosen team or sportsperson without the need for additional accessories that they will need to hold on to until they are required. In addition, the embodiments of the invention described herein act as both a standard supporter jersey (having a team logo or name, for example) and a support banner/accessory.

Furthermore, the jersey is likely to last a lot longer than typical disposable, or single use, support banners and the like. For instance, the jersey is able to be re-used at subsequent events. As the jersey is made of a durable material, such as cotton or polyester, it is less likely to degrade or become damaged between uses, as may be the case for other, typically used supporter accessories. This also potentially reduces the amount of items going to waste and to landfill.

In this specification, adjectives such as first and second, left and right, top and bottom, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step, etc.

The above detailed description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the spirit and scope of the above described invention.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

Throughout the specification and claims (if present), unless the context requires otherwise, the term “substantially” or “about” will be understood to not be limited to the specific value or range qualified by the terms.

1. A supporter jersey comprising a wearable top having a front portion connected to a back portion, wherein the front portion is at least partially detachable from the back portion.

2. The supporter jersey in accordance with claim 1, wherein the jersey comprises a first indicia located on an internally facing surface of the front portion of the jersey.

3. The supporter jersey in accordance with claim 2, wherein the jersey further comprises a second indicia located on an externally facing surface of the jersey opposite the first indicia.

4. The supporter jersey in accordance with claim 1, wherein the jersey comprises a sleeveless jersey having a front portion and a back portion.

5. The supporter jersey in accordance with claim 4, wherein the front and back portions comprise seamless side edge portions releasably fastened to each other.

6. The supporter jersey in accordance with claim 5, wherein the seamless side edge portions may be releasably fastened by one or more fasteners.

7. The supporter jersey in accordance with claim 6, wherein the fasteners comprise one or more press studs, zippers, one or more buttons and complementary buttons holes or a hook and loop fastener.

8. (canceled)

9. The supporter jersey in accordance with claim 1, wherein the front portion and the back portion are stitchedly attached at a shoulder portion of the jersey.

10. The supporter jersey in accordance with claim 9, wherein the shoulder portion may comprise a strap that rests on the shoulder of a wearer.

11. The supporter jersey in accordance with claim 1, wherein the front portion and the back portion are connected by two opposing side portions extending between the front portion and the back portion.

12. The supporter jersey in accordance with claim 11, wherein the side portions are releasably connected or releasably attached to the front portion on opposing sides of the front portion by one or more fasteners.

13. The supporter jersey in accordance with claim 1, wherein the jersey comprises an undergarment portion.

14. The supporter jersey in accordance with claim 13, wherein the undergarment portion comprises a material layer adjacent the front portion.

15. The supporter jersey in accordance with claim 13, wherein the undergarment portion is located between the front portion and the back portion.

16. The supporter jersey in accordance with claim 13, wherein the undergarment is attached to the back portion and/or side portions and the undergarment portion is located within the jersey.

17. (canceled)

18. The supporter jersey in accordance with claim 1, wherein the front portion and the back portion comprise a material layer.

19. The supporter jersey in accordance with claim 12, wherein the side portions are fixedly connected to the back portion.

20. The supporter jersey in accordance with claim 1, wherein the front portion and the back portion are connected by at least two fixedly connecting portions.

21. The supporter jersey in accordance with claim 1, wherein the partially detachable front portion is operable to be moved between a first position and a second position along a longitudinal axis, wherein the longitudinal axis extends longitudinally through the jersey.

22. The supporter jersey in accordance with claim 9, wherein the front portion and the back portion are detachable along two opposing longitudinal connectors connecting the front portion and the back portion and wherein the front portion and the back portion remain fixedly connected along a lateral seam extending across the shoulder portion of the jersey.
